(19) United States
(12) Patent Application Publication
(10) Pub. No.: US 2009/0297324 A1
(43) Pub. Date: Dec. 3, 2009

(54) Supply Module for Pallets, Having a Transport Module Movable Together With a Lifting Device Beneath the Stacking Bays of the Pallets

(76) Inventor: Helmut Jaeger, Koenigsbach-Stein (DE)

Correspondence Address: Walter A. Hackler, Ph.D.;Patent Law Office, 2372 S.E. Bristol Street, Suite B, Newport Beach, CA, 92660-0755, US

(21) Appl. No.: 12/226,307

(22) PCT Filed: Feb. 16, 2007
(86) PCT No.: PCT/DE2007/000304

§ 371 Date: Aug. 3, 2009

(30) Foreign Application Priority Data
Apr. 21, 2006 (DE) 10 2006 019 153.6

(51) Int. Cl. B65G 57/30; B65G 59/06

(52) U.S. Cl. 414/795.7; 414/802; 414/801

(57) ABSTRACT

The invention describes a supply module for stackable pallets, on which workpieces and/or tools can be disposed. On the supply module there are disposed several stacking bays arranged in succession in a row, at each of which a stack of pallets can be mounted in holding means, such as hooks. At least one transport module can be driven along the row beneath the stacking bays, the transport module carrying a lifting device with it. A pallet or a stack of pallets can be gripped from below by the lifting device. The supply module according to the invention can manage a large number of stacking bays, and hence pallets, in a cost-effective manner, even large stack heights being possible.

The invention relates to a supply module for pallets, on which workpieces can be transported,
having several first stacking bays for pallets,
   wherein the first stacking bays are arranged in a horizontal x-direction in succession in a first row,
   wherein each stacking bay comprises a stacking space extending in the vertical direction and a set of holding means that are arranged at the edge of the stacking space,
having a plurality of similar pallets, which can be stacked vertically on one another and each comprise a set of lock means, one set of lock means and one set of holding means being able to co-operate such that a pallet or, by means of its bottom pallet, also a stack of pallets, can be suspended in a stacking space,
and having at least one lifting device, which is movable vertically (=z-direction) and is able to grip a pallet or a stack of pallets from below.

Such a supply module is known from the company brochure of Siemens “Magaziniersystem für Werkstücke und Paletten” [Storage system for workpieces and pallets], 1985.

In modern manufacturing and assembly processes, workpieces and also tools for transport and storage are often handled not directly, but by means of standardised workpiece carriers and tool carriers, called pallets. One or more workpieces or tools can be placed in a pallet, the pallet protecting the workpieces or tools from damage such as scratches or dents caused by gripping devices or by inadvertent contact with hard objects. For the sake of simplicity, the following description refers only to workpieces, which are transported in a pallet.

The cycle of manufacturing and assembly processes often requires the workpieces to be stored temporarily before a machining operation and to be supplied to a machining device as required. Consequently, the pallets too have to be stored temporarily.

In a simple storage facility, pallets can be placed side by side on the floor. This requires very considerable storage space. To save on storage space, firstly, high-bay racking systems having a plurality of bays one above the other are known. Secondly, pallets can be stacked on top of one another. In both cases, a transport device for handling individual pallets must be able to span a relatively large vertical lift, corresponding to the height of the top bay of the high-bay racking system or corresponding to the height of a stack of pallets. Suitable transport devices are expensive. In addition, large vertical distances to be traversed by the transport device slow down the retrieval of pallets.

The Siemens storage system, cf. above, allows pallet stacks of basically any height to be handled with a lift of a transport device of only about the height of one pallet. The storage system comprises two stacking bays, each having its own lifting device. The lifting device is arranged beneath the stacking space of a stacking bay. Each stacking space comprises a set of four engageable retaining latches. The bottom pallet can be held using the retaining latches. To unload a pallet from a held stack, the lifting device moves towards the bottom pallet, the retaining latches are disengaged, the lifting device moves the stack down by the height of one pallet and the retaining latches are engaged again in order to hold the second from bottom pallet together with the remainder of the stack. The bottom pallet is then held only by the lifting device. For stacking, this process can be carried out in reverse. A manufacturing station is arranged between the stacking bays, and pallets can be moved between the lifting devices and the manufacturing station using a transport comb.

The disadvantage of this storage system is that each stacking bay requires its own lifting device. The storage system therefore quickly becomes expensive when stock requirements are large. Furthermore, the retaining latches at the stacking bays must be movable for the stacking processes, the result being that the retaining latches are not very robust. This restricts the stack height that can still be safely handled.

### TECHNICAL PROBLEM OF THE INVENTION

The invention accordingly addresses the problem of providing a supply module for pallets, which is of simpler and more robust construction. In particular, the storage system is intended to be able to handle even a large number of stacking bays cost-effectively, wherein a relatively large stack height shall be safely usable at each stacking bay.

### SUMMARY OF THE INVENTION

That problem is solved by a supply module of the kind presented in the introduction, which is distinguished by the fact that the holding means at the stacking bays are rigidly formed, at least one transport module that is movable as desired in the x-direction beneath a plurality of first stacking bays is provided, and a lifting device is constructed on each transport module.

According to the invention, at least one transport module can be moved under the stacking bays. The transport module has it own lifting device, which moves together with the transport module. This lifting device can therefore be used with a plurality of stacking bays, and preferably at all stacking bays.

Should several transport modules be used, the transport modules generally interfere with each other and each transport module can reach only some of the stacking bays. According to the invention there are then, however, stacking bays that can be reached by several transport modules (overlap bays), so that pallets can be transferred between the transport modules by means of the overlap bays.

The transport module can not only be moved in the x-direction from stacking bay to stacking bay, but can also stop between the stacking bays. Mobility of the holding means (engagement or disengagement), as required in the prior art during stacking and de-stacking, is therefore unnecessary in the case of the invention. A pallet or even a stack of pallets can be lifted out of the holding means and moved in the x-direction laterally next to the holding means, so that the holding means do not impede a vertical movement of the pallet or the stack of pallets. The holding means can consequently be of rigid, i.e. immovable construction. The rigid holding means can be of a more robust construction than movable holding means.

According to an especially preferred embodiment of the supply module according to the invention, provision is made for the at least one transfer module to be movable in a horizontal y-direction, the x-direction and the y-direction being oriented perpendicular to one another, for several second stacking bays to be provided, the second stacking bays being arranged in the x-direction in succession in a second row, and the first row and the second row being arranged adjacent in the y-direction, and for the at least one transport module to be movable as desired in the x-direction also beneath a plurality of second stacking bays. The row of second stacking bays considerably increases the capacity of the supply module, all stacking bays being freely accessible from at least one side, for instance for gantries. Within the scope of the invention, three or even more rows of stacking bays can be arranged side by side in the y-direction, stacking bays then lying inside preferably being used only for storage/back-up supply.

In a development of this embodiment, the at least one transfer module is movable in the y-direction by a fixed axle with two stops. With this embodiment, the second stacking spaces can be approached in an especially cost-effective manner.

A very especially preferred embodiment of the supply module according to the invention is distinguished in that precisely one transport module is provided, and in that the transport module is movable as desired in the x-direction beneath all stacking bays. This embodiment is especially simple and avoids any requirement for co-ordination between several transport modules. It is especially suitable when there is a small number of stacking bays, for example, 1-10 stacking bays.

In the case of a likewise preferred alternative embodiment, several transport modules are provided, wherein each stacking bay can be approached by at least one of the transport modules. The supply of pallets can be accelerated by several transport modules, in particular when there is a large number of stacking bays in the supply module, for instance more than 10 stacking bays.

Furthermore, an embodiment in which the at least one transfer module is movable in the x-direction by means of a NC linear axis is preferred. In this way, even brief movements, as are used for moving pallets (pallet stacks) in and out, can be controlled well.

An embodiment in which the lifting device is in the form of a scissors lift table is also advantageous. The scissors lift table is of simple construction and is tried and tested.

An embodiment is also preferred in which at least one stacking bay positioned at one end of a row of stacking bays is formed on a dolly, and the dolly can be uncoupled from the remainder of the supply module. Pallets can be introduced into and discharged from the supply module using the dolly. In accordance with the invention, in the coupled-up state the stacking bay of the dolly can be approached by at least one transport module of the supply module.

In an advantageous refinement of this embodiment, two stacking bays that are located at opposite ends of a row of stacking bays can each be formed on a dolly. This facilitates a linear interlinking of several supply modules.

Another advantageous refinement provides for a rail guide for a dolly, in particular wherein the rail guide leads to a further supply module. The rail guide facilitates management of the dolly.

In an advantageous embodiment of the supply module according to the invention, the lock means and the holding means each have a width in the x-direction that is very much smaller than the width PB of a suspended pallet in the x-direction. Typically, this width of the holding means and lock means amounts to less than one fifth of PB. This shortens the distances travelled during lateral insertion and extraction of a pallet. Typically, the lock means project from the remaining pallet in the y-direction and/or the holding means project in the y-direction into the stacking space.

Furthermore, the supply module preferably comprises at least three first stacking bays. From this number of stacking bays onwards, economies in respect of the number of lifting devices come into their own.

An embodiment in which at least one gantry is provided is advantageous, the gantry being able to handle workpieces of a pallet of a stacking bay (=supply bay). The gantry can transfer the workpieces to a machine tool (for instance a turning lathe). Generally speaking, only one pallet is arranged at a supply bay.

In a preferred refinement of this embodiment, at least two stacking bays are in the form of supply bays. The two supply bays are served by the same gantry. A pallet exchange can then be effected at one supply bay whilst at the other supply bay the workpieces are fed to the processing point. The efficiency of a machine tool at the gantry can consequently be increased.

Another advantageous refinement provides for the gantry to run transversely to the x-direction. The gantry then has particularly little effect on stacking bays other than the supply bays.

Also advantageous is a refinement in which at least one workpiece machine tool, in particular a turning lathe or a milling machine, is arranged at the at least one gantry. The machine tool can be supplied with workpieces by means of the gantry and the remaining supply module.

Also preferred is an embodiment that is distinguished by the provision of a co-ordination bay, which comprises several sets of holding means that are arranged on the supply module offset in the x-direction by an amount V with respect to one another, wherein the amount V is less than the width PB of a pallet suspended at the co-ordination bay in the x-direction. At the co-ordination bay, a pallet can be suspended in several x-positions. Each position is optimised for access to one or more of the workpieces on the pallet for, for example, a gantry. A movement axle during access to the workpiece, for instance on the gantry, can consequently be eliminated. Note that several sets of holding means are preferred, but are not necessarily arranged equidistant at the co-ordination bay.

In an advantageous refinement, provision is made for several workpieces to be disposed on the pallets with an offset of V in the x-direction. The workpiece positions are in this case preferably defined by holders on the pallet. The standardised pallets facilitate the co-ordination.

In another preferred embodiment of the supply module according to the invention, a co-ordination frame is provided, on which at least one set of holding means is provided, and the co-ordination frame is movable in the x-direction by means of a transport device. With the movable co-ordination frame, a co-ordination independent of the transport module is possible.

An embodiment in which at least some of the stacking bays are formed by stacking bay modular units is very especially preferred, wherein the stacking bay modular units are arranged to be reversibly connectable in the x-direction with similar stacking bay modular units. The stacking bay modular units enable the supply module to be easily modified or extended. In accordance with the invention a reversible connection can also exist in the y-direction between adjacent rows.

A method for stacking an additional pallet under a stack of pallets also falls within the scope of the invention, the stack being mounted in a set of holding means by means of a set of lock means of a bottom pallet of the stack, and the additional pallet likewise having a set of lock means, the method comprising the following steps:
a) the additional pallet is moved from below towards the bottom pallet of the stack (=stacking);
b) the additional pallet together with the stack is lifted until the lock means of the bottom pallet of the stack are located completely above the holding means (=lifting out);
c) the additional pallet together with the stack is moved so far horizontally in an x-direction that the lock means of the bottom pallet are arranged completely laterally of the holding means (=moving out);
d) the additional pallet together with the stack is lifted until the lock means of the additional pallet are arranged completely above the holding means (=lifting);
e) the additional pallet together with the stack is moved back so far horizontally in the x-direction that the lock means of the additional pallet lie directly above the holding means (=moving in);
f) the additional pallet together with the stack is lowered, so that the lock means of the additional pallet hook into the holding means (=hooking in).
   The stacking process according to the invention dispenses with any mobility of the holding means, the result being that the holding means can be of more robust construction and higher stacks are manageable. With a vertical lift of a little more than a pallet height, in principle stacks of any height can be stacked up. In accordance with the invention, instead of one additional pallet an additional stack of pallets can be stacked under a first stack of pallets, in which case in step d) the lift must be sufficient for the lock means of the bottom pallet of the additional stack to be arranged completely above the holding means.

A method for de-stacking a bottom pallet from a stack of pallets also falls within the scope of the present invention, the stack being mounted in a set of holding means by means of a set of lock means of the bottom pallet of the stack, and a second from bottom pallet likewise having a set of lock means, the method comprising the following steps:
a) the stack is lifted until the lock means of the bottom pallet of the stack are located completely above the holding means (=lifting out);
b) the stack is moved so far horizontally in an x-direction that the lock means of the bottom pallet are arranged completely laterally of the holding means (=moving out);
c) the stack is lowered until the lock means of the bottom pallet are arranged completely below the holding means, and the lock means of the second from bottom pallet are arranged completely above the holding means (=lowering);
d) the stack is moved back so far horizontally in the x-direction that the lock means of the second from bottom pallet lie directly above the holding means (=moving in);
e) the stack is lowered, so that the lock means of the second from bottom pallet hook into the holding means (=hooking in).
f) the bottom pallet is lowered so that it is separated from the second from bottom pallet (=de-stacking). Again, no movable holding means are required for this stacking process. In accordance with the invention, instead of de-stacking a bottom pallet, a bottom stack part can be de-stacked, in which case in step c) it must be lowered sufficiently far for the lock means of the top pallet of the stack part to be arranged completely below the holding means, and for the lock means of the next pallet up to be arranged completely above the holding means.

The two methods mentioned are advantageously carried out with a supply module according to the invention.

Further advantages of the invention are apparent from the description and the drawings. The above-mentioned features and the features mentioned further below can be used alone or jointly in any combination. The embodiments shown and described are not to be understood as a conclusive list, but are merely of a representative nature for illustration of the invention.

### BRIEF DESCRIPTION OF THE DRAWINGS

The invention is illustrated in the drawings and is explained in greater detail by means of exemplary embodiments. In the drawings:

FIG. 1 shows a diagrammatic side view of a supply module according to the invention with a row of stacking bays;

FIG. 2a shows the supply module of FIG. 1 in a diagrammatic side view;

FIG. 2b shows a detail view of the supply module of FIG. 1;

FIG. 3a shows a diagrammatic plan view of a set of holding means and a set of lock means of a pallet in the hooked-in state;

FIG. 3b shows a diagrammatic plan view of a set of holding means and a set of lock means of a pallet in the moved-out state;

FIGS. 4a-h show a succession of side views of holding means and pallets with lock means during the de-stacking process according to the invention;

FIG. 5 shows a diagrammatic view of a co-ordination bay for a supply module according to the invention in plan view;

FIG. 6 shows a diagrammatic view of a co-ordination frame for a supply module according to the invention in plan view;

FIG. 7 shows a diagrammatic view of a supply module according to the invention with two rows of stacking bays.

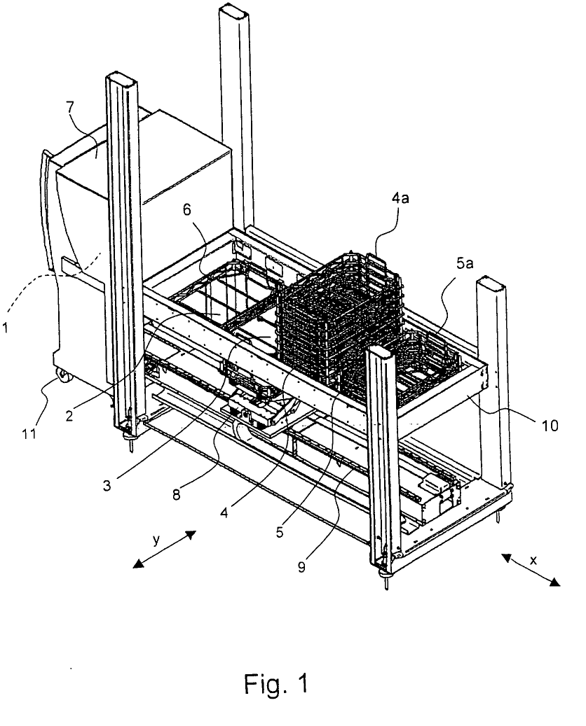

FIG. 1 shows a supply module according to the invention having a total of five stacking bays 1, 2, 3, 4, 5 for pallets 6. The stacking bays 1-5 are arranged in succession in a horizontal x-direction. The stacking bay 1 is formed in a dolly 7. No pallets are currently mounted in the stacking bay 3 and a single pallet 6 is mounted in stacking bay 2. Pallet stacks 4a, 5a are mounted in stacking bays 4 and 5 respectively.

Beneath the stacking bays 1-5 is arranged a transport module 8, which is progressively displaceable along a guide 9 in the x-direction beneath all stacking bays 1 to 5.

The supply module comprises a stationary frame 10, within which the stacking bays 2 to 5 are formed. The dolly 7, on the other hand, can be separated from the frame 10 (and also be re-attached to the frame 10) and be moved on castors 11.

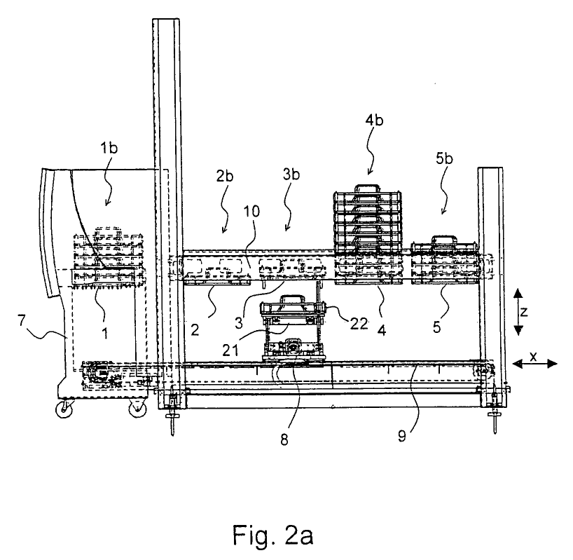

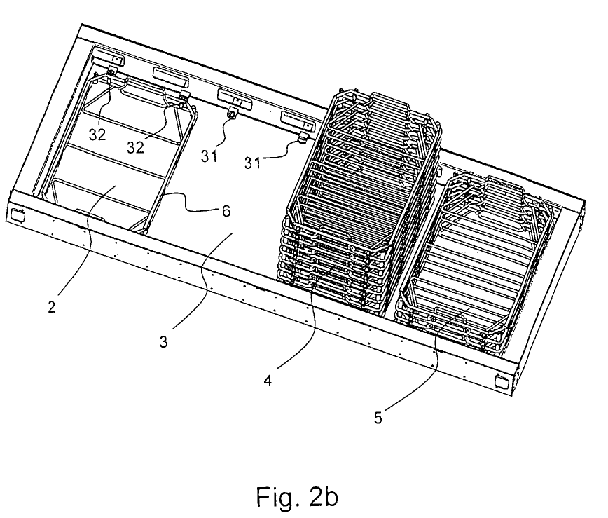

FIG. 2a shows a side view of the supply module of FIG. 1. The transport module 8 comprises a lifting device 21, that is to say a scissors lift table, which is currently supporting a pallet 22. The guide 9 of the transport module 8 extends under the stacking bay 1 in the dolly 7 and there can be used in particular for the stacking bay 1.

The stacking bays 1 to 5 each comprise a stacking space 1b-5b, which extends vertically (upwards) and in which a pallet stack can be formed. Stacking and de-stacking is effected from the bottom. In a downward direction, the stacking spaces 1b-5b are defined by holding means, which are formed on the frame 10 and on the dolly.

FIG. 2b shows a detail view of the stacking bays 2 to 4 of the supply module of FIG. 1. The holding means 31, into which a pallet can be hooked, are clearly visible at stacking bay 3. Also visible on the pallet 6 in stacking bay 1 are the lock means 32.

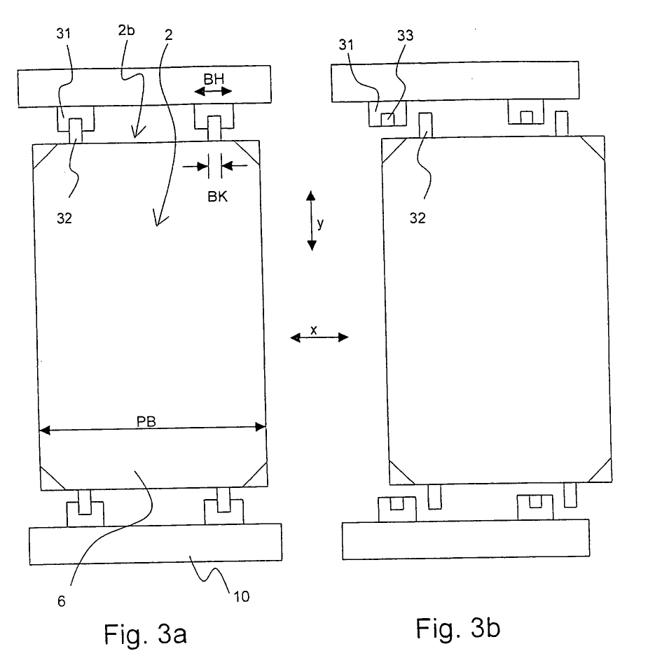

A hooking-in mechanism is also diagrammatically illustrated in FIG. 3a. FIG. 3a shows a pallet 6 in the hooked-in state at stacking bay 2. A set of four holding means 31 is secured to the frame 10 of the supply module. The holding means 31 project in the y-direction into the stacking space 2b of the stacking bay 2. The holding means 31 are in the form of projections with a small recess (perpendicular to the plane of the drawing).

The pallet 6 has a set of four lock means 32, which project away from the pallet 6 in the y-direction. The lock means 32 are in the form of bolts.

In the hooked-in state shown, the bolts of the lock means 32 lie in the recesses of the projections of the holding means 31. The pallet 6 is thereby held.

The width BH of the holding means 31 and the width BK of the lock means 32 are each considerably smaller than the width PB of the pallet 6 in the x-direction. This consequently ensures that only a small distance in the x-direction, compared with the pallet width PB, is required to move out the pallet 6.

FIG. 3b shows diagrammatically the pallet 6 of FIG. 3a in an unhooked, moved-out state. The lock means 32 are offset in the x-direction with respect to the holding means 31. In this position, the pallet 6 can be moved vertically (perpendicular to the plane of the drawing) upwards or downwards, without the holding means 31 and the lock means 32 impeding each other.

In the holding means 31 there are formed recesses 33, which align the lock means in the x-direction and y-direction and secure them in the hooked-in state in the horizontal direction. The recesses preferably become narrower in a downward direction in the x and/or y-direction in order to guide the lock means 32.

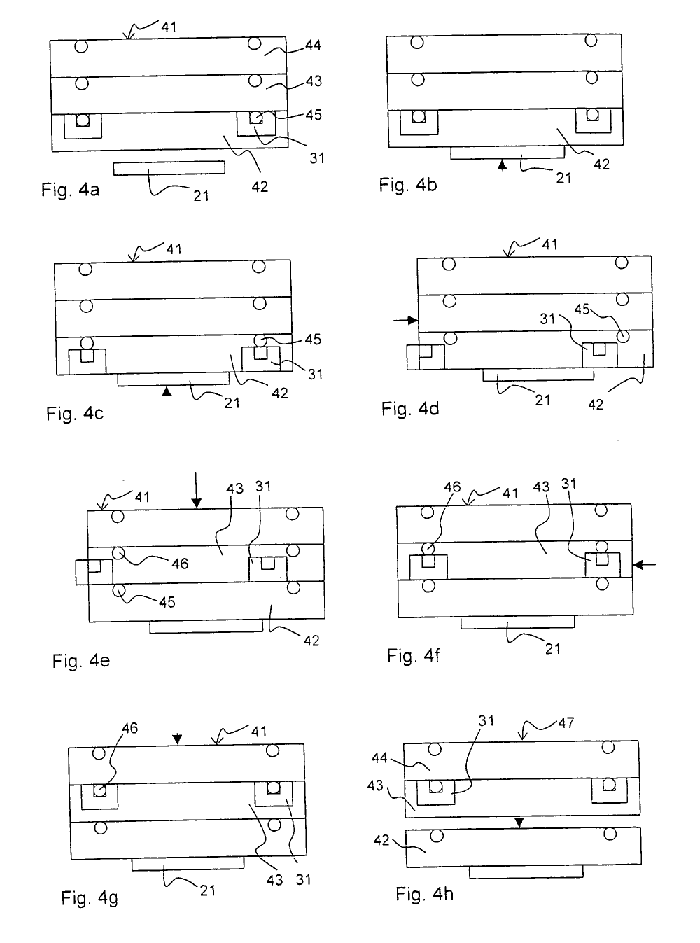

FIG. 4a to 4h illustrate diagrammatically the stacking process according to the invention applied to a stack 41 of pallets 42, 43, 44. De-stacking of the bottom pallet 42 from the stack 41 is illustrated in the progression from FIG. 4a to 4g.

FIG. 4a shows the initial situation. The stack 41 is held in the holding means 31 by the lock means 45 of the bottom pallet 42. A lifting device 21 is provided beneath the stack 41.

FIG. 4b shows the situation after the lifting device 21 has been moved up to the underside of the pallet 42.

In FIG. 4c, the lifting device 21, and hence also the stack 41, has been lifted upwards far enough for the lock means 45 of the bottom pallet 42 to lie completely above the holding means 31. The stack 41 can then be moved in the x-direction (here shown to the right).

FIG. 4d shows the moved-out state. The lock means 45 of the bottom pallet 42 have been moved laterally far enough for them to be arranged completely adjacent to the holding means 31. A vertical displacement of the stack 41 is thereby rendered possible.

Lateral movement (in the x-direction) is effected by means of the transport module, to which the lifting device 21 is secured.

The stack 41 is now lowered, namely until the lock means 45 of the bottom pallet 42 lie completely below and the lock means 46 of the second from bottom pallet 43 lie completely above the holding means 31, as shown in FIG. 4e.

The pile 41 is then moved in horizontally with the transport module, so that the lock means 46 of the second from bottom pallet 43 are arranged directly above the holding means 31. This state is shown in FIG. 4f.

The stack 41 is now lowered by means of the lifting device 21 until the lock means 46 of the second from bottom pallet 43 hook into the holding means 31, as shown in FIG. 4g.

As the lifting device 21 is lowered further, only the pallet 42 is moved further, whereas the pallets 43, 44 form a reduced residual stack 47, which remains hooked into the holding means 31, see FIG. 4h.

In order to add an additional pallet from below to a stack of pallets, the above-described process can be carried out in reverse, i.e. from FIG. 4h to FIG. 4a, movement being in the opposite direction to the marked arrows in each case. The pallet 42 represents the additional pallet and is added to the residual stack 47.

Note that it is sufficient within the scope of the invention if the lifting device approaches three different z-positions (for instance with stops). The total lift of the lifting device merely has to amount to the height of a pallet plus a small safety margin (so that a pallet can be moved with safe clearance under suspended pallets).

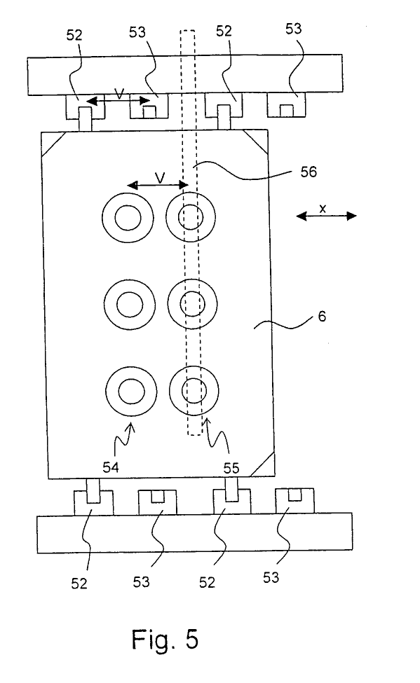

FIG. 5 illustrates diagrammatically in plan view a co-ordination bay 51 for the invention. The co-ordination bay 51 comprises a first set of holding means 52 and a second set of holding means 53. The two sets are spaced or offset from one another in the x-direction by an amount V.

The first set of holding means 52 holds a pallet 6, on which several workpieces are arranged in two rows 54 and 55. Recesses or profiles for holding the workpieces can be provided on the pallet 6. The rows 54, 55 have a spacing or offset, likewise amounting to V, in the x-direction on the pallet 6.

The workpieces of the right-hand row 55 are located directly beneath a stationary gantry 56 and its guide rail, so that the workpieces of the row 55 can be managed by the gantry (for instance to bring the workpieces to a machining station). The workpieces of the row 54, on the other hand, are not within the range of the gantry 56.

In order to bring the workpieces of the row 54 within the range of the gantry 56, the pallet 6 can be transferred to the holding means 53. The result of this would be that the workpieces of the row 54 would be positioned by the amount V further to the right, and hence directly beneath the gantry 56.

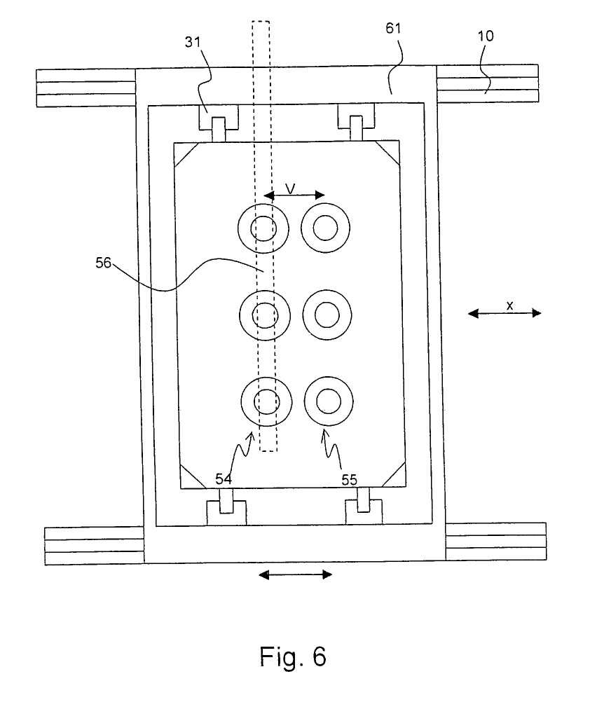

A co-ordination frame 61 for the invention is illustrated diagrammatically in FIG. 6. The co-ordination frame 61 is slidable in the x-direction, in particular under motor control, on a stationary frame 10 of the supply module. A set of holding means 31 is formed on the co-ordination frame 61. A pallet 6 with two rows 54, 55 of workpieces is formed on the holding means 31. The left-hand row of workpieces 54 is arranged beneath a stationary gantry 56, which is able to manipulate the workpieces of the row 54. In order to bring the workpieces of the row 55 into the range of the gantry 56, the co-ordination frame 61, and hence also the pallet 6, can be displaced by the amount V to the left in the x-direction. V corresponds to the spacing or offset of the two rows 54 and 55 in the x-direction.

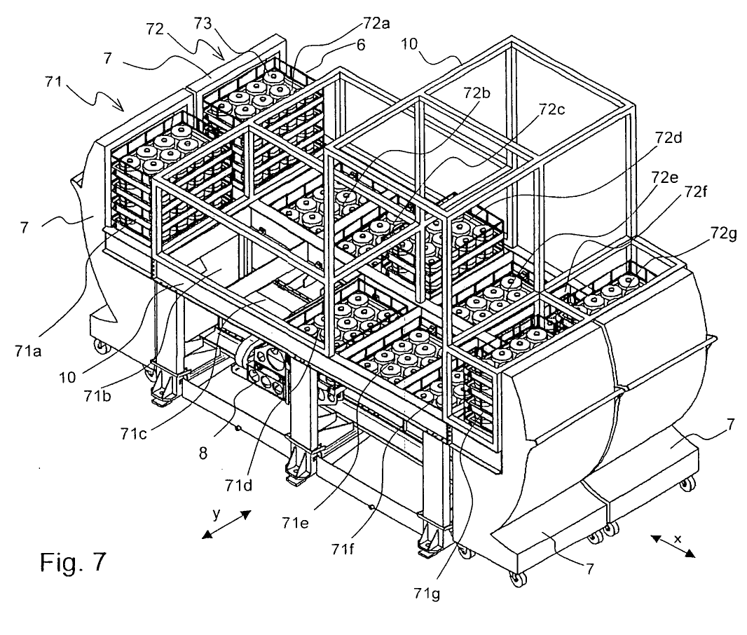

FIG. 7 shows an embodiment of a supply module according to the invention, which comprises first stacking bays 71a-71g in a first row 71 and second stacking bays 72a-72g in a second row 72. The alignment of the stacking bays is effected in each row 71, 72 in the x-direction and the rows 71, 72 are immediately adjacent in the y-direction. No pallets, or one pallet, or a stack of pallets are suspended in the stacking bays. In most instances, workpieces 73 are arranged in the pallets (pallet 6 is marked by way of example).

Beneath the stacking bays is arranged a transfer module 8, which is in the form of a flat module and can be moved in the x and y-directions beneath all stacking bays 71-71g, 72a-72g. The transfer module 8 comprises a lifting device, which can engage with a bottom pallet at a stacking bay.

The stacking bays 71a, 71g, 72a, 72g are formed on dollies 7, a dolly 7 being arranged at opposite ends of each of the two rows 71 and 72. The dollies 7, together with the stack of pallets arranged on them, can be individually separated from the stationary frame 10 and be moved (manually or by means of a motor drive). To facilitate movement of the dollies 7, rails or guides can be provided in the floor.

The stacking bays 71e, 71f, 72e, 72f are used as supply bays. Generally, only a single pallet is suspended at these bays. The frame 10 of the supply module is raised in the region of these stacking bays 71e, 71f, 72e, 72f, in order to provide easier access for gantries (not shown). A gantry running in the y-direction can be provided for the stacking bays 71e, 71f, and a further similar gantry can be provided for the stacking bays 72e, 72f (not shown). Using the gantries, individual workpieces 73 can be removed from the pallets 6 or placed on the pallets 6.

The transfer module 8 is controlled by means of an electronic system, not shown.

To summarise, the invention describes a supply module (“standby basket”) for stackable pallets 6; 22; 42, 43, 44 on which workpieces 73 and/or tools can be disposed. The supply module contains a plurality of stacking bays 1, 2, 3, 4, 5; 71a-71g, 72a-72g arranged in succession in a row 71, 72, at each of which a stack 4a, 5a, 41 of pallets can be mounted in holding means 31, 52, 53, such as hooks. At least one transport module 8 can be driven along the row beneath the stacking bays, the transport module carrying a lifting device 21 with it. The lifting device can grip a pallet or a stack of pallets from below. The supply module according to the invention can manage a large number of stacking bays, and hence pallets, in a cost-effective manner, even large stack heights being possible.

What is claimed is:

1. Supply module for pallets on which workpieces can be transported, said supply module comprising:
a plurality of first stacking bays for pallets, the first stacking bays being arranged in a horizontal x-direction in succession in a first row, each stacking bay comprising a stacking space extending in a vertical direction;
a set of rigidly formed holding means, disposed at an edge of each stacking space for hooking a pallet;
a plurality of similar pallets, stackable vertically on one another with each comprising a set of lock means, one set of lock means and one set of holding means being able to co-operate in order that one pallet or, a stack of pallets, can be suspended in a stacking space;
at least one lifting device, movable vertically (=z-direction) for griping a pallet or a stack of pallets from below; and
at least one transport module movable as desired in the x-direction beneath a plurality of first stacking bays for supporting the lifting device.

2. Supply module according to claim 1, wherein at least one transfer module is movable in a horizontal y-direction, the x-direction and the y-direction being oriented perpendicular to one another, and the supply module comprises a plurality of second stacking bays, the second stacking bays being arranged in succession in the x-direction in a second row, and the first row and the second row being arranged adjacent in the y-direction, and the at least one transport module is movable as desired in the x-direction also beneath a plurality of second stacking bays.

3. Supply module according to claim 2, wherein the at least one transfer module (8) is movable in the y-direction by a fixed axle with two stops.

4. Supply module according to claim 1, wherein that exactly one transport module is provided, and the transport module is movable as desired in the x-direction beneath all stacking bays.

5. Supply module according to claim 1, wherein several transport modules are provided, and wherein each stacking bay can be approached by at least one of the transport modules.

6. Supply module according to claim 1, wherein at least one transfer module is movable in the x-direction by means of a NC linear axis.

7. Supply module according claim 1, wherein the lifting device is in the form of a scissors lift table.

8. Supply module according to claim 1, wherein at least one stacking bay is positioned at one end of a row of stacking bays is formed on a dolly, and in that the dolly can be uncoupled from the remainder of the supply module.

9. Supply module according to claim 8, wherein two stacking bays located at opposite ends of a row of stacking bays are each formed on a dolly.

10. Supply module according to claim 8, further comprising a rail guide for the dolly, the rail guide leading to a further supply module.

11. Supply module according to claim 1, wherein the lock means and the holding means each have a width (BK, BH) in the x-direction that is very much smaller than the a width PB in the x-direction of a suspended pallet.

12. Supply module according to claim 1, wherein the supply module comprises at least three first stacking bays.

13. Supply module according to claim 1, further comprising at least one gantry for manipulating workpieces of a pallet of a stacking bay.

14. Supply module according to claim 13, wherein at least two stacking bays are in the form of supply bays.

15. Supply module according to any one of claim 13 wherein the gantry runs transversely to the x-direction.

16. Supply module according to claim 13 further comprising at least one workpiece machine tool arranged at the at least one gantry.

17. Supply module according to claim 1, further comprising a co-ordination bay comprising several sets of holding means arranged offset in the x-direction by an amount V with respect to one another on the supply module, wherein the amount V is less than the width PB in the x-direction of a pallet suspended at the co-ordination bay.

18. Supply module according claim 17, wherein the workpieces are arranged on the pallets with an offset of V in the x-direction.

19. Supply module according to claim 1, further comprising a co-ordination frame for supporting at least one set of holding means, the co-ordination frame being movable in the x-direction by a transport device.

20. Supply module according to claim 1, wherein at least some of the stacking bays are formed by stacking bay modular units, wherein the stacking bay modular units are arranged to be reversibly connected in the x-direction with similar stacking bay modular units.

21. Method for stacking an additional pallet beneath a stack of pallets, the stack being mounted in a set of holding means by means of a set of lock means of a bottom pallet of the stack, and the additional pallet likewise having a set of lock means, the method comprising:
a) moving the additional pallet from below towards the bottom pallet of the stack;
b) lifting the additional pallet together with the stack until the lock means of the bottom pallet of the stack are located completely above the holding means;
c) moving the additional pallet together with the stack horizontally in an x-direction in order that the lock means of the bottom pallet are arranged completely laterally of the holding means;
d) lifting the additional pallet together with the stack until the lock means of the additional pallet are arranged completely above the holding means;
e) moving the additional pallet together with the stack horizontally in the x-direction in order that the lock means of the additional pallet lie directly above the holding means; and
f) lowering the additional pallet together with the stack, so that the lock means of the additional pallet hook into the holding means.

22. Method for de-stacking a bottom pallet from a stack of pallets, the stack being mounted in a set of holding means by means of a set of lock means of the bottom pallet of the stack, and a second from bottom pallet likewise having a set of lock means, the method comprising:
a) lifting the stack until the lock means of the bottom pallet of the stack are located completely above the holding means;
b) moving the stack horizontally in an x-direction in order that the lock means of the bottom pallet are arranged completely laterally of the holding means;
c) lowering the stack until the lock means of the bottom pallet are arranged completely below the holding means, and the lock means of the second from bottom pallet are arranged completely above the holding means;
d) moving the stack horizontally in the x-direction in order that the lock means of the second from bottom pallet lie directly above the holding means;
e) lowering the stack in order that the lock means of the second from bottom pallet (43) hook into the holding means and
f) lowering the bottom pallet in order that the bottom pallet is separated from the second from bottom pallet.

23. Method according to claim 21, wherein the method is carried out with a supply module according to claim 1.

24. Method according to claim 22 wherein the method is carried out with a supply module according to claim 1.
